(19) United States
(12) Patent Application Publication
(10) Pub. No.: US 2010/0217725 A1
(43) Pub. Date: Aug. 26, 2010

(54) APPARATUS FOR AUTOMATIC FINANCIAL PORTFOLIO MONITORING AND ASSOCIATED METHODS

(76) Inventors: Miles A. Clyne, Prince George (CA); Michael Lawson Townrow, Prince George (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/711,997

(22) Filed: Feb. 24, 2010

Related U.S. Application Data
(60) Provisional application No. 61/155,124, filed on Feb. 24, 2009.

(51) Int. Cl. G06Q 40/00

(52) U.S. Cl. 705/36 R; 705/37

(57) ABSTRACT

A tool for use by financial professionals such as portfolio managers monitors values of assets in portfolios and maintains buy and sell levels for the assets. The tool can be configured to recommend the sale of an asset where the asset value has increased in a gain run by at least the corresponding sell level and the value of the asset in the portfolio is more than a target allocation. The tool can be configured to recommend the purchase of an asset where the asset value has decreased in a drop run by at least the corresponding buy level and the value of the asset in the portfolio is less than a target allocation. The tool may monitor a balance in a non-volatile account and coordinate the transfer of funds from sales of assets into the non-volatile account. Machine implemented methods can assist management of financial portfolios.

### REFERENCE TO RELATED APPLICATION

This application claims the benefit of U.S. patent application Ser. No. 61/155,124 filed on 24 Feb. 2009 and entitled APPARATUS FOR AUTOMATIC FINANCIAL PORTFOLIO MONITORING AND ASSOCIATED METHODS under 35 U.S.C. §119, which is hereby incorporated by reference herein.

### TECHNICAL FIELD

This invention relates to financial securities and in particular to apparatus useful for assisting a financial portfolio manager to manage portfolios of financial assets and to related machine-implemented methods.

### BACKGROUND

It is common for investors to own portfolios of financial instruments such as stocks, bonds, shares in mutual funds and the like. Investors hope that their portfolios will grow in value over time. Since the future performance of individual financial instruments is often unpredictable, a good portfolio is typically made up of several different financial instruments.

When a financial portfolio is initially set up the investor may choose a set of financial instruments and decide how to initially allocate funds among the financial instruments in the portfolio. These decisions may be based on factors such as the investor's tolerance of risk, the time over which the investor intends to invest and the like. For example, an investor may decide to invest in a portfolio made up of shares in a money-market fund and shares in three different mutual funds. The investor may initially invest equal amounts in each of these different assets. For example, if the investor initially has $100,000 to invest, the investor may start a portfolio by investing $25,000 in each of these different assets.

As time passes, the different assets which make up the portfolio will change in value. This generally happens at different rates for different assets. The result is that, over time, the percentage of the value of the portfolio made up by different ones of the assets in the portfolio changes. For example, consider the above example where, over time, a first one of the mutual funds appreciates by 100% and each of the other assets in the portfolio appreciates by only 20%. The total value of the portfolio is now $140,000 but now, instead of having relative values of 25:25:25:25, the different assets in the portfolio now have relative values of 50:30:30:30.

It is thought to be good practice to periodically ‘rebalance’ financial portfolios. Rebalancing typically involves selling a portion of any asset having a value such that the portfolio includes more than a desired allocation of that asset and using the sale proceeds to purchase more of assets having values such that the portfolio includes less than a desired allocation of those assets. In the above example, rebalancing might involve selling $15000 worth of the first mutual fund (leaving $35000 invested in the first mutual fund) and using the $15000 proceeds to purchase $5000 of each of the three other assets. The result being that the portfolio will have $35000 invested in each of the four assets which make it up, restoring the allocation to 25% for each asset in the portfolio.

Of course, it is not necessary for a desired allocation of assets in a financial portfolio to specify equal amounts of each assets. The desired allocation may specify any suitable allocation of the value in a portfolio among the assets of the portfolio.

Many investors retain financial professionals for assistance in setting up and managing financial portfolios. Such financial professionals are entrusted with managing their clients' money. A financial professional may have a large number of clients. In many cases it is not practical for a financial professional to monitor every client portfolio on a day-to-day basis and to exercise his or her professional judgment to make decisions and/or recommendations regarding each individual portfolio.

Some clients arrange to have a financial professional automatically rebalance their portfolios on fixed dates. This can ensure that the risk of the portfolios remain reasonably consistent with the volatility of the initial allocation of those investments. However, it has been established that managing a portfolio according to a policy of regularly rebalancing the portfolio to its original allocation reduces the capital appreciation potential of most portfolios. Investors may give up higher returns for the perceived safety of this process.

Some clients arrange to have a financial professional automatically rebalance their portfolios upon based upon a change in value of one or more assets in the portfolio by a fixed percentage, either up or down. Portfolios managed under such rebalancing schemes suffer from the same potentially reduced returns as portfolios that are automatically rebalanced on fixed dates. This is at least in part because, under normal circumstances, the values of most investments fluctuate dramatically enough to cross the thresholds that cause rebalancing under such schemes.

The inventor has determined that such financial professionals have a need for automated systems capable of assisting them to make appropriate and timely recommendations and/or financial decisions on behalf of their clients.

The patent literature includes patents and patent applications relating to financial management. These include the following United States patent applications:

2008/0249960;

2008/0010181;

2008/0065522;

2007/0294158;

2006/0010060;

2006/0010053;

2005/0171883;

2005/0187851;

2005/0108148;

2004/0210500;

2004/0181479;

2003/0187771;

2003/0065602; and

2002/0138383;

and the following United States patents:

U.S. Pat. No. 7,472,084;

U.S. Pat. No. 7,412,424;

U.S. Pat. No. 7,346,520;

U.S. Pat. No. 7,395,236;

U.S. Pat. No. 7,337,137;

U.S. Pat. No. 7,216,099;

U.S. Pat. No. 7,165,044;

U.S. Pat. No. 7,120,601;

U.S. Pat. No. 6,985,880;

U.S. Pat. No. 6,928,418;

U.S. Pat. No. 6,393,409;

U.S. Pat. No. 6,317,726;

U.S. Pat. No. 6,275,814;

U.S. Pat. No. 6,021,397;

U.S. Pat. No. 5,818,238;

U.S. Pat. No. 5,812,987; and

U.S. Pat. No. 5,729,700.

There remains a need for tools and automated methods useful for assisting financial managers to effectively manage financial portfolios.

### SUMMARY OF THE INVENTION

This invention has a range of aspects. Some aspects relate to machines which automatically monitor portfolios of assets and generate recommendations for portfolio management. The recommendations are based at least in part upon past values of the assets. Other aspects of the invention relate to methods for automatically monitoring financial portfolios and alerting human users or automated systems at optimum times for taking portfolio management steps such as buying or selling assets. Other aspects relate to machines and/or methods that provide additional portfolio maintenance and management functionality.

Further aspects of the invention and features of specific embodiments of the invention are described below.

### BRIEF DESCRIPTION OF THE DRAWINGS

The accompanying drawings illustrate non-limiting embodiments of the invention.

FIG. 1 is a flow chart which illustrates a method according to an example embodiment.

FIG. 1A is a flow chart which illustrates a method that may be used for establishing parameter values based on historical data.

FIGS. 1B and 1C are charts illustrating example changes in value of an asset over a number of periods.

FIG. 1D is a chart illustrating an example change in value in a portfolio over the time of a simulation.

FIGS. 2A and 2B are flow charts respectively illustrating example methods for extracting average gain per gain run and average drop per drop run from historical asset value data.

FIGS. 3 and 3A are respectively flow charts which illustrate methods for recommending asset purchases and sales according to example embodiments.

FIG. 3B illustrates a step for updating desired asset allocations.

FIG. 3C illustrates an example portfolio record.

FIG. 4 illustrates a portfolio management tool according to an example embodiment.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

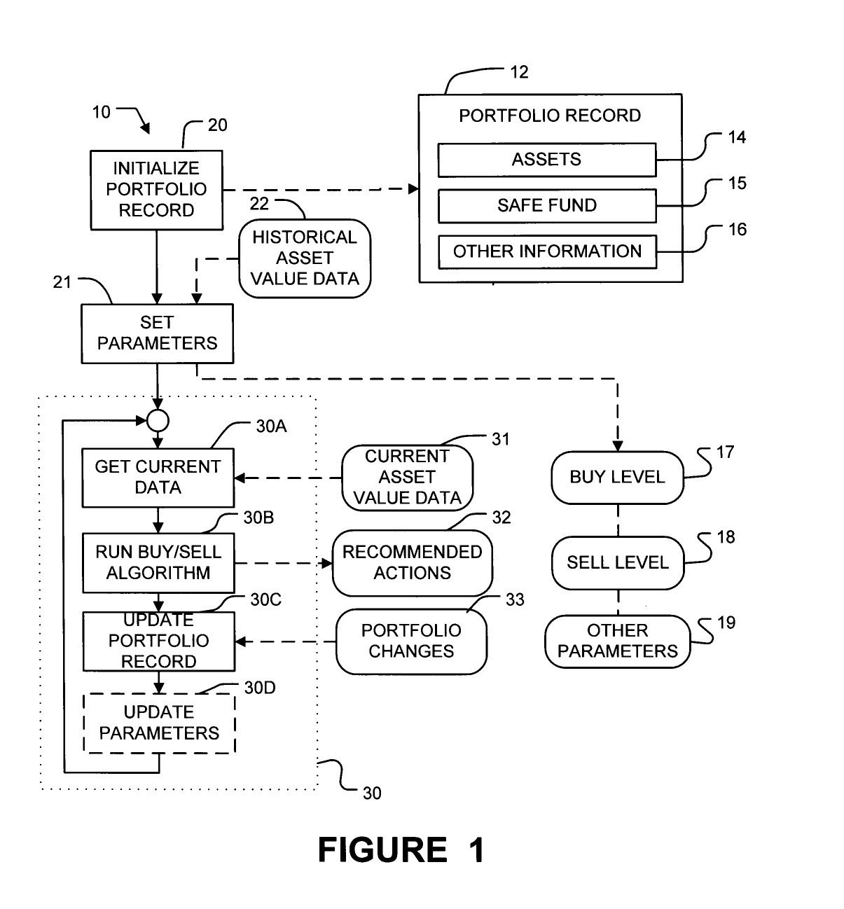

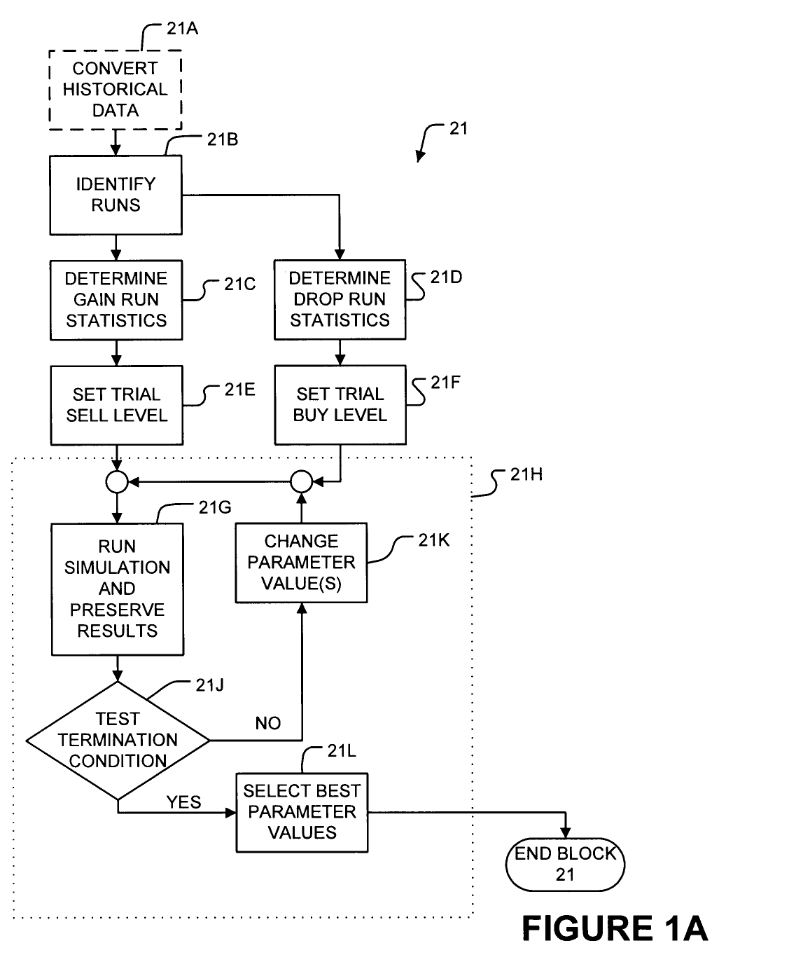

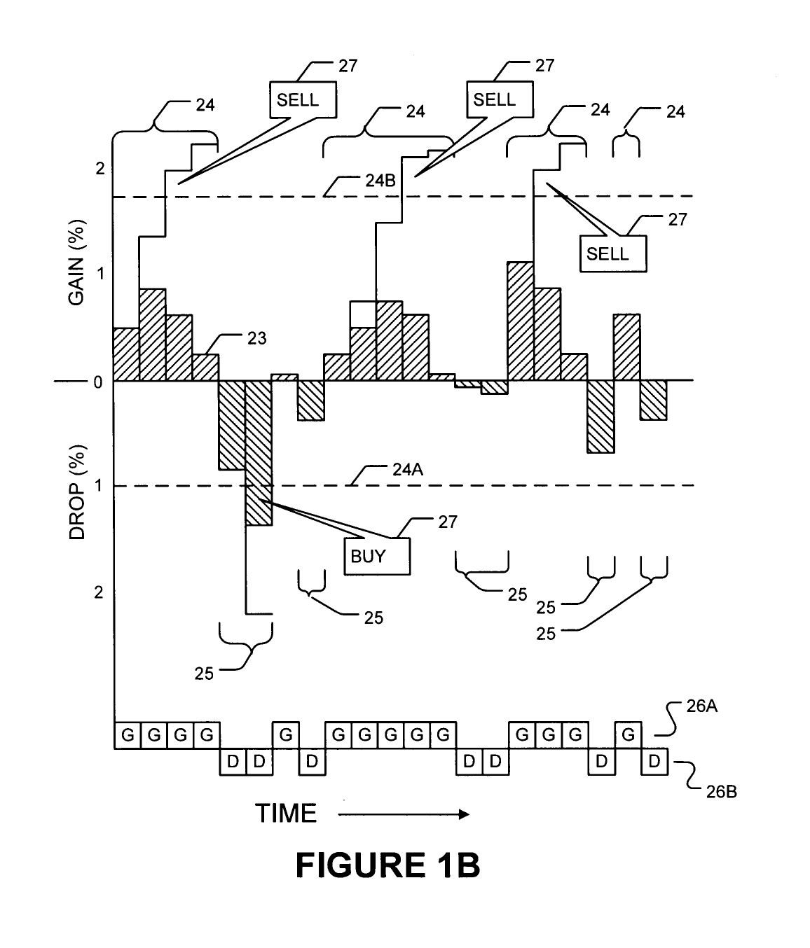

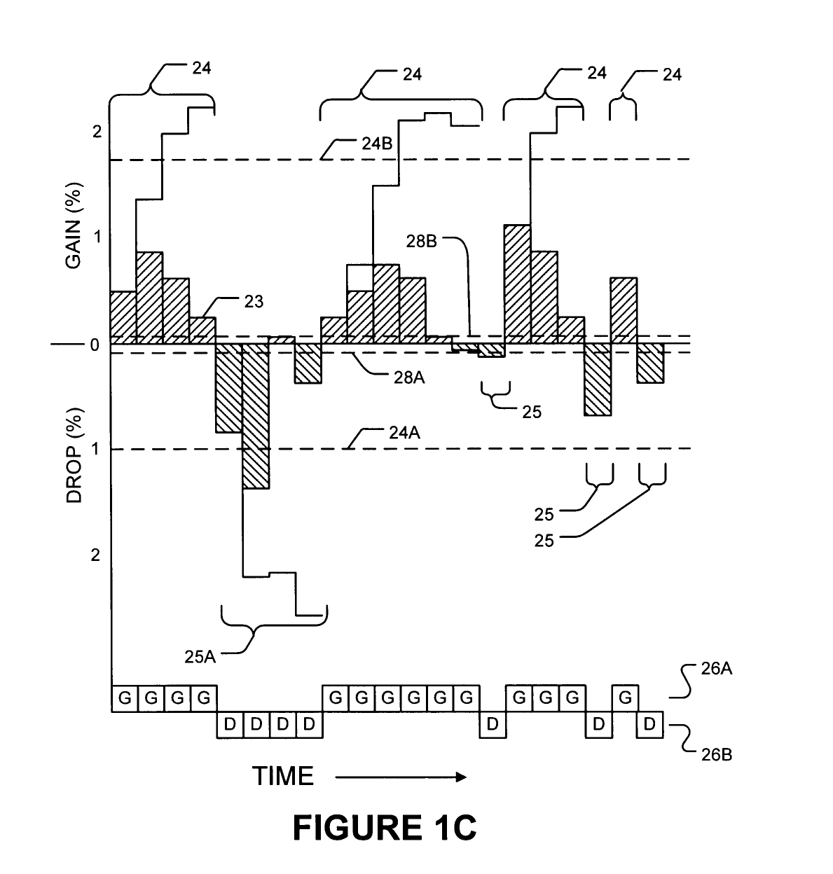

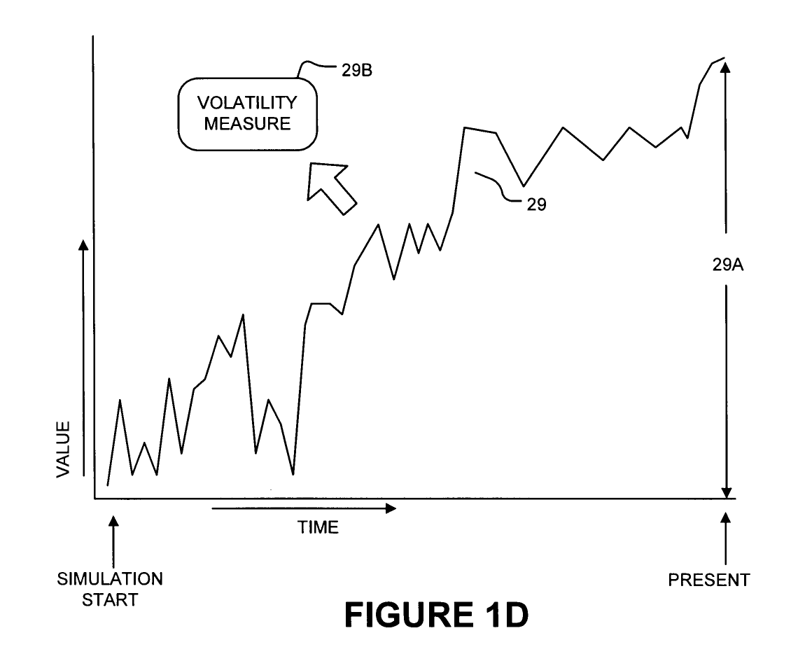

FIG. 1 illustrates a method 10 according to an example embodiment of the invention. The method is performed automatically by a machine, which may comprise an automatic decision support tool. The machine may be or comprise a programmed data processor, an electronic device comprising special purpose hard-wired logic circuits, configurable logic circuits (such as field-programmable gate arrays), combinations thereof, or the like, configured to implement the method illustrated in FIG. 1.

Method 10 monitors portfolio records 12. Each portfolio record 12 represents a financial portfolio made up of a number of assets 14. The assets in the financial portfolio may all be owned by an individual or the portfolio may be the portfolio of a fund managed for multiple individual investors. The assets are typically assets like stocks, mutual funds, index funds, and the like that can be added to by purchasing more units of the asset or sold in part by selling some of the units of the asset contained in the portfolio. Portfolio records 12 contain information 14 identifying: assets in a portfolio; information 15 indicating a balance in a non-volatile safe fund, such as a cash account or the like; and other information 16. Records 12 can reflect specific values of assets in the portfolio.

In the illustrated embodiments, each portfolio also includes a ‘safe’ fund such as a cash account, money market account or the like into which proceeds from the sale of any asset may be kept or from which funds can be used to purchase additional assets. The safe fund is preferably a non-volatile fund whose value tends not to fluctuate much or at all with changes in the market for other assets. Each portfolio record 12 includes a balance 15 for the safe fund for the corresponding portfolio. The safe fund balance 15 typically corresponds to the balance in an account holding money available for purchasing assets for the portfolio or for redemption.

In block 20, a portfolio record 12 is initialized. Block 20 comprises selecting a set of assets to be in a portfolio. Block 20 may comprise retrieving a portfolio record 12 that has been created by a separate portfolio management system; receiving user input selecting or otherwise identifying assets for inclusion in portfolio record 12; selecting a template identifying a previously-selected set of assets; or the like. In some embodiments, block 20 comprises setting a desired allocation of value among the assets to be included in portfolio 12. Where the assets for the portfolio are not already owned, block 20 may comprise purchasing the set of assets and maintaining the purchased assets in one or more accounts such that record 12 corresponds to the assets being held for the portfolio in the one or more accounts.

In block 21, method 10 establishes parameters for a buy/sell algorithm including a ‘buy’ level 17 and a ‘sell’ level 18 for each asset in a portfolio 12. Other parameters 19 may also be specified in block 21. The buy and sell levels 17 and 18 are based at least in part on historical value data for the asset in question.

The buy and sell levels 17 and 18 may be expressed in a range of different ways. The buy and sell levels directly or indirectly constitute thresholds that can be compared to the current unit value for an asset in the portfolio to determine whether or not it would be advisable to sell some or all of the asset or to buy more of the asset. By way of non-limiting example, the buy and sell levels may be expressed as: percentage gains, asset unit values, multiples of original asset acquisition costs, or the like. In the following example embodiment, the buy and sell levels are expressed as proportional gains or losses in a current run, as explained in more detail below.

Block 21 comprises, for each asset in a portfolio 12 performing an analysis of historical value data 22 corresponding to the asset. Historical value data 22 comprises a record of values for the assets over time. Historical data 22 may be provided in a database, an on-line repository or the like. In some embodiments method 10 comprises maintaining historical data 22 for assets in portfolios being managed by method 10 in a local database and block 21 comprises looking up historical data 22 in the local database. In other embodiments, block 21 comprises retrieving historical data or results of analysis of the historical data from a file, database, suitable server or other data source by way of the internet or another data communication network.

In an illustrated embodiment, historical data 22 comprises, for each asset, a dataset that specifies changes in the value for the asset over a series of periods. It is convenient for the periods to be equal in length. For example, the historical data may provide historical changes in the unit value for an asset for a series of days, weeks, biweeks, months, or periods of any other suitable length. The changes may be expressed as percentages, decimal fractions, binary fractions or any other suitable representation. Table I provides an example data set.

TABLE I
Example Historical Data for an Asset

| | Value Change |
|---|---|
| Period | in Period |
| January 2003 | +1.0012% |
| February 2003 | +2.1121% |
| March 2003 | −0.3426% |
| April 2003 | −0.5462% |
| May 2003 | +1.5112% |
| . . . | . . . |
| July 2009 | −3.3345% |
| . . . | . . . |

In some embodiments, method 10 comprises converting historical data 22 from a format in which asset values are specified at specific times to a format in which changes in the value for the asset are specified over a series of periods.

In specific embodiments, buy levels are set based at least in part upon an average drop for drop runs in historical data 22 and sell levels are set based at least in part upon an average gain for gain runs in historical data 22. In such embodiments, analysis of historical data 22 for an asset may comprise automatically identifying and counting runs in historical data 22.

FIG. 1A shows an example of the analysis that may be performed in block 21. In block 21A, historical data 22 is converted, if necessary, into data which provides a percentage (or other proportional) value change over each of a series of historical periods. It is convenient to make all of the periods have the same length (e.g. one week, one month, N days, M months, where M and N are counting numbers, or the like).

In block 21B, historical data 22 for the asset is analyzed to identify ‘runs’. A run is a sequence of one or more consecutive time periods represented in historical data 22 wherein the value of the asset is trending upward (gain runs) or trending downward (drop runs). In some embodiments block 21B comprises allowing a user to select all or a portion of historical data 22 to analyze. For example, block 21B may comprise receiving a user input indicating a start date, a number of periods to use or the like for the analysis of historical data 22. This input may be made for all historical data 22 or for assets individually.

A “gain run” can be identified as a sequence of one or more time periods over which the asset value increases and for which the asset value does not decline at all or does not decline much in any period. In different embodiments, gain runs may be identified, for example, as:
a sequence of one or more consecutive time periods over which the value of the asset increases in each period;
a sequence of one or more consecutive time periods over which the value of the asset increases and in which any drops are smaller than some threshold amount;
a sequence of one or more consecutive time periods over which the value of the asset increases and, in each period the asset value increases by at least a “Gain End Value”. In some embodiments the gain end value is a configurable parameter that can be positive, negative or zero.

A “drop run” can be identified as a sequence of one or more consecutive time periods for which the asset value decreases and either does not increase at all or, in some embodiments, does not increase much in any one period. In different embodiments, drop runs may be identified, for example, as:
a sequence of one or more consecutive time periods over which the value of the asset decreases in each period;
a sequence of one or more consecutive time periods over which the value of the asset decreases and in which any increases are smaller than some threshold amount;
a sequence of one or more consecutive time periods over which the value of the asset decreases and, in each period the asset value decreases by at least a “Drop End Value”. In some embodiments the drop end value is a configurable parameter that can be positive, negative or zero.

FIG. 1B shows a curve 23 representing the changes in value for an asset over a number of periods. Curve 23 may represent an excerpt from historical data 22 for one asset. In the data illustrated by curve 23, the value for the asset experienced a number of gain runs 24 and a number of drop runs 25. Each period is annotated with a “G” in row 26A if the period is or is included in a gain run and a “D” in row 26B if the period is or is part of a drop run. A buy level 24A and a sell level 24B are also shown. When a cumulative increase in value of an asset over a current gain run equals or exceeds the sell level then logic considers whether to recommend sale of the asset.

When a cumulative decrease in value of an asset over a current drop run equals or exceeds the buy level then logic considers whether to recommend purchase of the asset. Flags 27 indicate times when “buy” and “sell” recommendations may be made.

FIG. 1C shows the same curve 23 from FIG. 1B in the case where the buy/sell algorithm uses a gain end value 28A and a drop end value 28B for determining when gain and drop runs end. In the illustrated embodiment, gain end value is negative and drop end value is positive. In the illustrated embodiment, a drop run is considered to end when, during a period, the value of the asset increases by more than drop end value 28B. Similarly, a gain run is considered to end when, during a period, the value of the asset decreases by more than gain end value 28A. It can be observed that the choice of values for gain end value and drop end value parameters can alter the number and lengths of gain runs and drop runs identified in the data represented by curve 23.

In block 21C statistical information is extracted for the gain runs. In a simple embodiment, the statistical information comprises a mean percentage increase in value for the gain runs. This may be determined, for example, by summing the increases in value for the asset over all gain runs in the historical data (or in a subset of the historical data—e.g. the last Q years, weeks or months of historical data) and dividing by the number of gain runs identified.

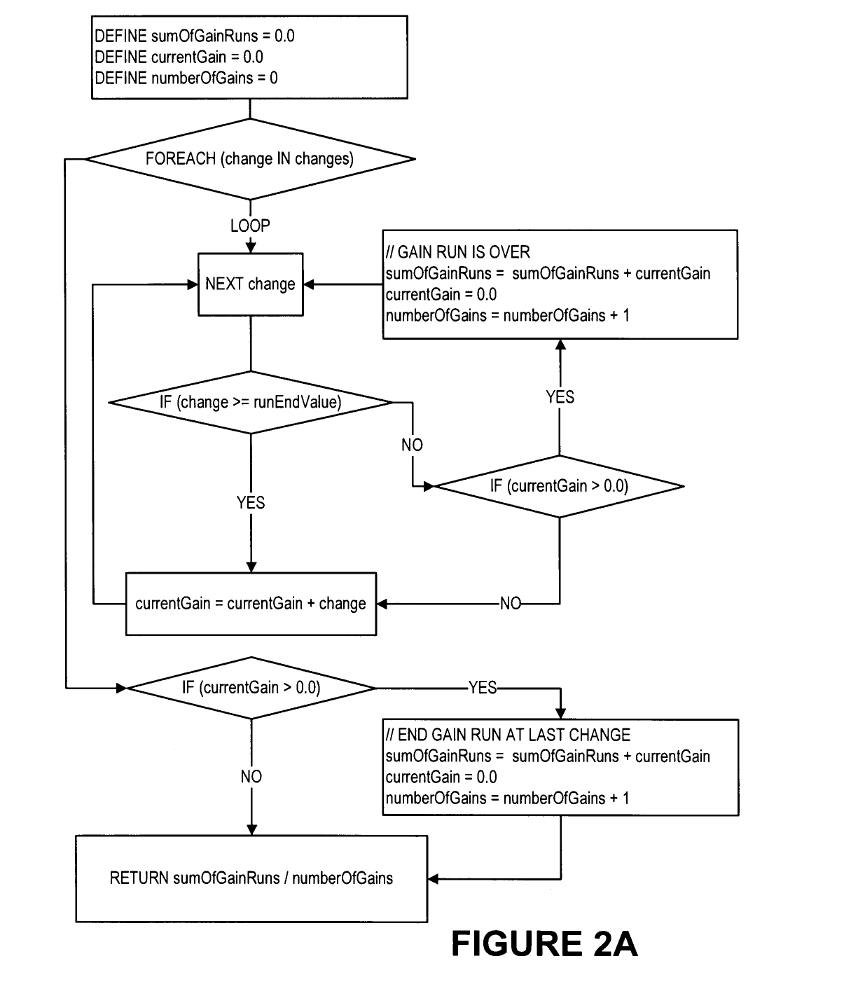

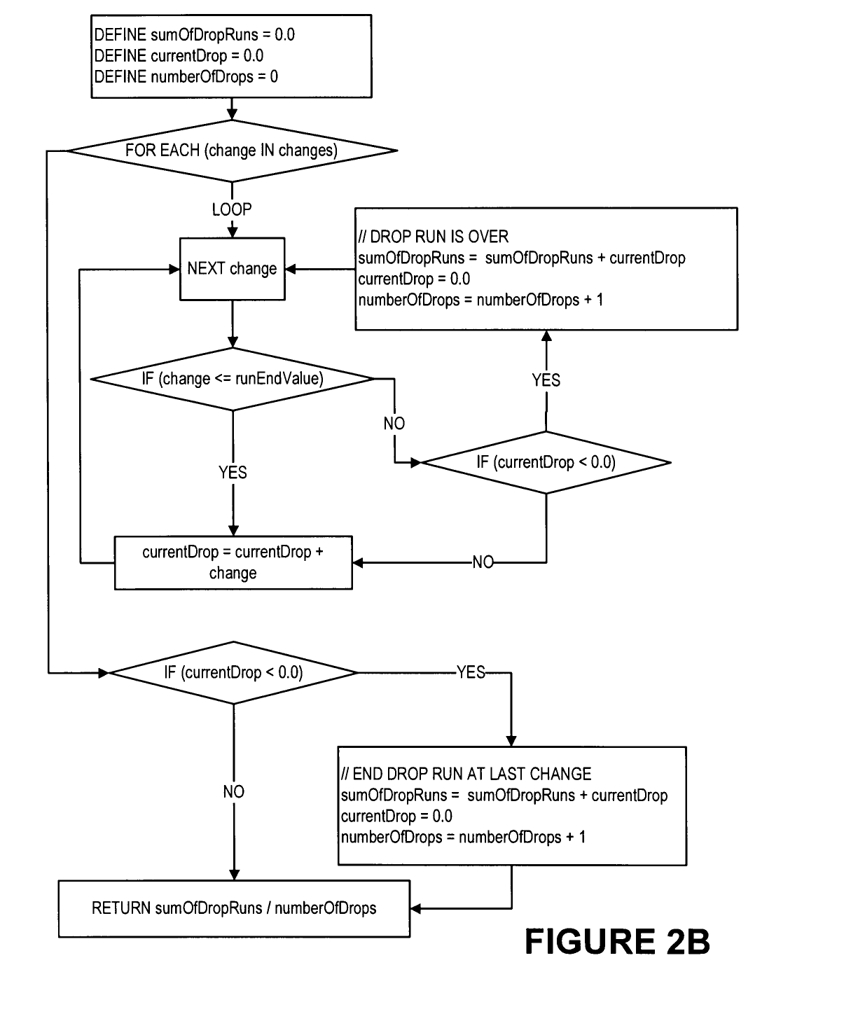

FIG. 2A is a flowchart illustrating a method 40 that may be applied for determining the average gain for gain runs in historical data. In FIG. 2A: sumOfGainRuns is a variable that accumulates a total sum of the increases in asset value for all gain runs; numberOfGains is a variable that accumulates a number of gain runs identified in the historical data; currentGain is a variable that accumulates a total gain for a current gain run; change is a variable that holds an increase or decrease in the asset value for a current period.

In block 21D statistical information is extracted for the drop runs. In a simple embodiment, the statistical information comprises a mean percentage decrease in value for the drop runs. This may be determined, for example, by summing the decreases in value for the asset over all drop runs in the historical data (or in a subset of the historical data—e.g. the last Q years weeks or months of historical data) and dividing by the number of drop runs identified.

FIG. 2B is a flowchart illustrating a method 41 that may be applied for determining the average drop for drop runs in historical data. In FIG. 2B: sumOfDropRuns is a variable that accumulates a total sum of the decreases in asset value for all drop runs; numberOfDrops is a variable that accumulates a number of drop runs identified in the historical data; currentDrop is a variable that accumulates a total drop for a current drop run; change is a variable that holds an increase or decrease in the asset value for a current period.

Blocks 21E and 21F respectively establish trial “buy level” 17 and trial “sell level” 18 for the asset. In an example embodiment, the buy level is a function of an average gain per gain run determined in block 21C and the sell level is a function of an average drop per drop run determined in block 21D.

In a prototype embodiment, buy level 17 is a product of a gain multiplier and the average gain per gain run and sell level 18 is a product of a drop multiplier and the average drop per drop run. The gain and drop multipliers comprise variable parameters. Typical values for a gain or drop multiplier are in the range of 0.1 to 6 (although values outside of this range may also be used).

Buy level 17 and sell level 18 may be applied to generate a recommendation that an asset be bought or sold according to a buy/sell algorithm that processes data representing the current value of the asset. For example, where an asset is currently experiencing a gain run, a ‘sell’ recommendation may be triggered when the increase in value of the asset since the start of the gain run equals or exceeds the sell level.

Similarly, where the asset is currently experiencing a drop run, a ‘buy’ recommendation may be triggered when the decrease in value of the asset since the start of the drop run equals or exceeds the buy level. In this example, results of the operation of the buy/sell algorithm can depend at least on the formulae used to determine the buy and sell levels, the criteria applied to identify gain runs and drop runs, and details of the operation of the buy/sell algorithm.

Embodiments of the invention permit tuning the operation of the buy/sell algorithm for a portfolio by running simulations of the operation of the buy/sell algorithm against historical data 22.

In block 21G, a simulation for the portfolio is run using the current buy levels 17 and sell levels 18 acting on the historical data 22 for the assets in the portfolio as well as current values for any other parameters in the buy/sell algorithm. The simulation measures how a modeled value of the portfolio value would have changed over a historical period had the assets in the portfolio been purchased and sold at times recommended by the buy/sell algorithm using the current buy levels 17 and sell levels 18 for the assets in the portfolio (as well as current values for any other parameters of the buy/sell algorithm).

In some embodiments, the buy/sell algorithm is responsive to a specified allocation of assets in a portfolio. Examples of embodiments in which the buy/sell algorithm provides such functions are described below.

In some embodiments, block 21G may also, or in the alternative, comprise running simulations for individual assets. Such simulations may measure how a modeled value for the individual asset would have changed over a historical period had the asset for which the simulation is being performed been purchased and sold at times determined based on parameters including the current buy level 17 and sell level 18 for the asset. In an example embodiment, block 21G comprises, computing what would be the current value achieved if an initial amount of the asset had been purchased at the start of a relevant historical period, the asset had been sold whenever the asset experienced a gain run for which an increase in value was at least equal to an amount determined by the sell level 18 and all proceeds from any earlier sale were saved and used to purchase the asset whenever the asset experienced a drop run for which a decrease in value was at least equal to an amount determined by the buy level 17.

In block 21H, the buy and sell levels 17 and 18 for the assets in the portfolio are optimized. Optimization may be performed in any of a variety ways. For example,
A user may interact with a tool running method 10 by way of a user interface to cause the method to try different values for parameters of the buy/sell algorithm including buy and sell levels 17 and 18 for different assets (or parameters specifying how the buy and sell levels relate to the historical data—for example, a gain multiplier in a formula that involves multiplying an average gain determined from the historical data by a gain multiplier to yield a sell level). The user can cause the tool to re-run simulation(s) like those performed in block 21F to identify a best set of buy and sell levels 17 and 18. In some embodiments, the user may also select values for parameters that affect identification of gain runs and loss runs. The tool stores the parameter values selected by the user in a suitable data store for later use.
An automatic optimization algorithm may be performed to identify a best set of buy and sell levels 17 and 18 (and other parameters of the buy/sell algorithm in some embodiments). Block 21H may involve any suitable optimization algorithm. For example, block 21H may implement any of: a brute-force optimization algorithm which tries all allowed values for buy level 17 and sell level 18 in some ranges; a simulated annealing optimization algorithm; or the like.
Previously-determined best buy and sell levels 17 and 18 for specific assets may be imported from a data source.

The optimization criterion applied in block 21H may be, for example, a criterion that seeks to:
maximize the increase in value of the portfolio (e.g. achieve the largest positive value change over the simulation period); or,
minimize the volatility in the value of the portfolio (e.g. achieve a curve having a smallest volatility value measured over the simulation period); or,
achieve a desired trade-off between maximizing the increase in value of the portfolio while maintaining a relatively low volatility; or
the like.

FIG. 1D shows a curve 29 that illustrates how the value of a portfolio may evolve over time if a buy/sell algorithm as described herein were applied with specific values for buy levels and sell levels for assets in a portfolio. A final value change 29A and/or a volatility measure 29B measuring a volatility of curve 28 may be determined from curve 28 or its underlying data.

Where the buy/sell algorithm for recommending purchases and sales of assets includes other parameters (e.g. a drop end value and/or a gain end value or other parameter that can be are applied to identify drop runs and gain runs) then block 21F may comprise optimizing such other parameters as well as optimizing buy and sell levels 17 and 18 for each asset in the portfolio. Drop end values, gain end values or their equivalents may be specified either for individual assets or groups of assets or for a portfolio.

In the illustrated embodiment, block 21J determines whether a termination condition for the optimization has been met. The termination condition may comprise input from a user indicating by way of a user interface that the user is satisfied with a certain parameter set; a termination condition based on a measure of a number of iterations of an optimization that have been performed; a termination condition based on a function that measures a rate at which an optimization is achieving improved results; some combination thereof, or the like. If the termination condition is not satisfied (NO result in block 21J) then, in block 21K the values for one or both of the buy level 17 and sell level 18 (and/or other parameters of the buy/sell algorithm) are changed and the simulation in block 21G is repeated. If the termination condition has been met (YES result in block 21J) then method 10 proceeds to block 21L which selects the best values for the buy levels 17 and sell levels 18 (as well as other parameters) for the current portfolio.

In block 30 of method 10 the buy/sell algorithm is run, using the parameters determined in block 21, against current data 31 for the values of assets in the portfolio. Block 30 may be performed any time that new data is available for any asset in a portfolio, at specified periods, or the like. Current data 31 is acquired at block 30A. The buy/sell algorithm is run at block 30B. The buy/sell algorithm determines if each asset in a portfolio ought to be sold, bought or held and makes recommendations 32 accordingly. The recommendations may be displayed, stored, logged, encoded in electronic signals, printed, or otherwise made tangible so that they can be acted on by a human user or machine. The recommendations may be accompanied by additional information that could be of assistance to a human user who is evaluating the recommendations. In block 30C, portfolio record 12 for the current portfolio is updated to take into account any portfolio changes 33. In block 30D, which is optional, parameters such as buy level 17, sell level 18 and/or other parameters 19 which affect the operation of the buy/sell algorithm are updated based upon the current asset value data.

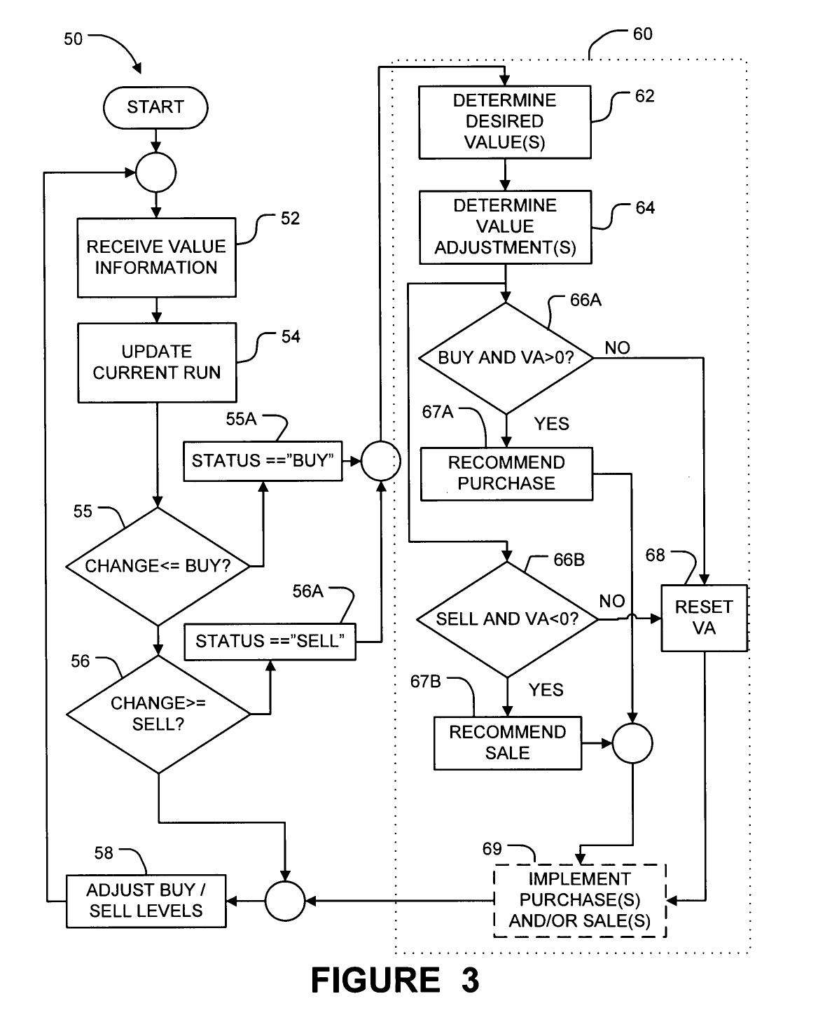

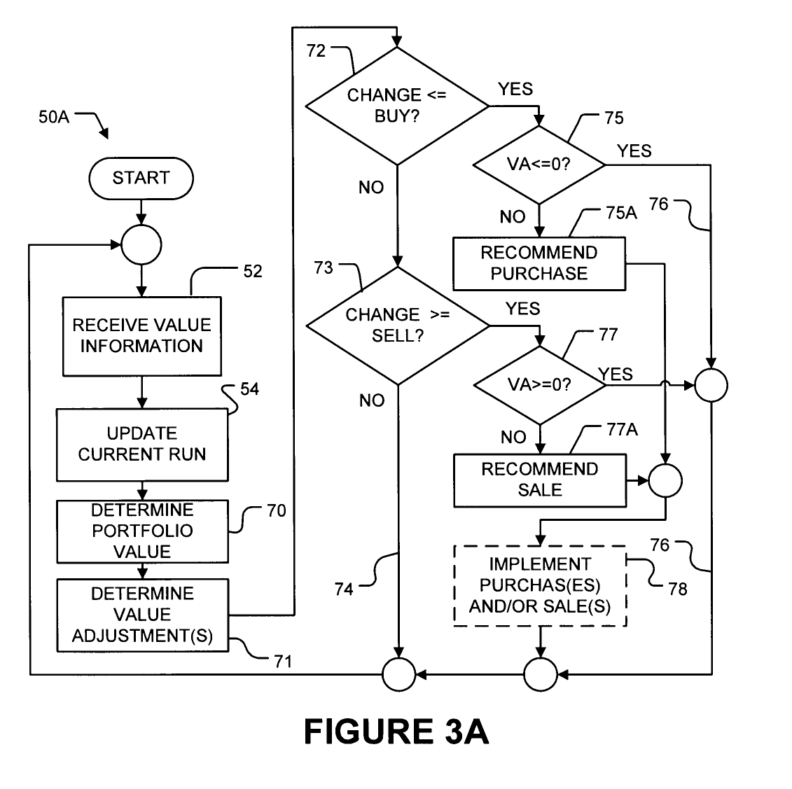

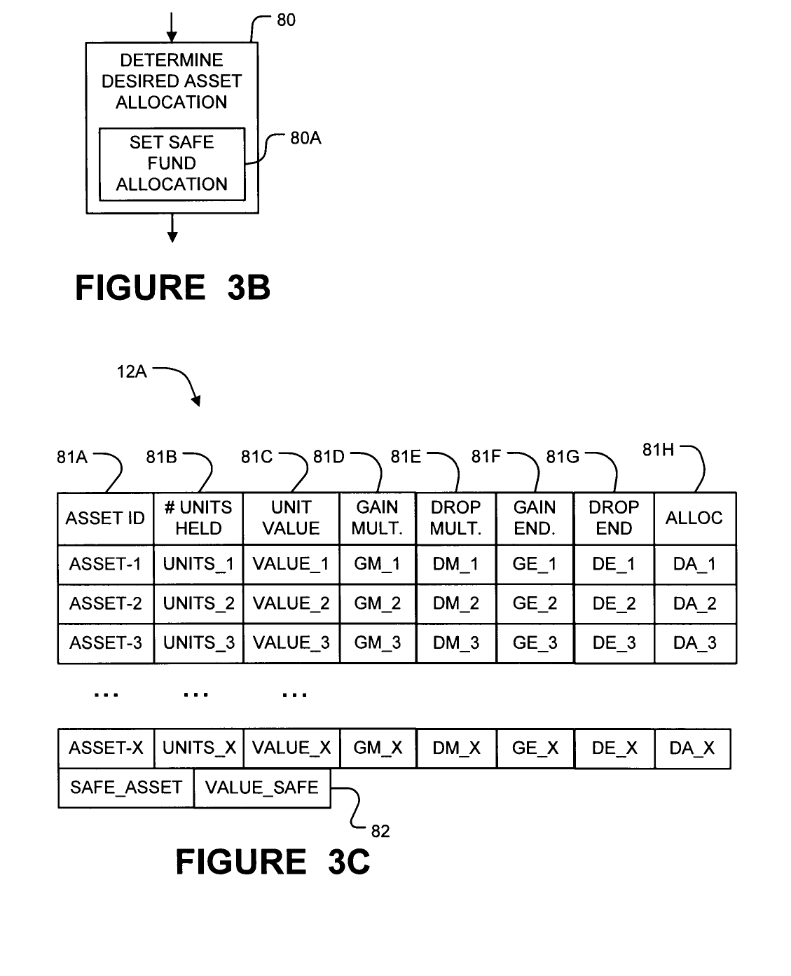

FIG. 3 illustrates the operation of a method 50 that may be performed in block 30 according to an example embodiment. Method 50 may be essentially the same as the buy/sell algorithm applied against historical data 22 in block 21G.

In block 52 current asset data is received. Block 54 determines whether the current asset data extends an existing gain run or drop run or indicates a start of a new gain or drop run. In either case, block 54 updates the total change for the current run (which may be either a gain or drop) based on the current asset data retrieved in block 52. In some embodiments, a gain run for an asset is treated as having ended when the buy/sell algorithm recommends a “sell” and a drop run is treated as having ended when the buy/sell algorithm recommends a “buy”. In such embodiments, a single extended run may be treated as two or more consecutive shorter runs.

Blocks 55 and 56 (which may be performed in any order or in parallel) respectively compare the total change for the current run to current buy and sell levels. If the total change is greater than or equal to the sell level then a status for the asset is set to “SELL” in block 56A. If the total change is less than or equal to the buy level then a status for the asset is set to “BUY” in block 55A. Otherwise in block 58, buy and sell levels are updated, if necessary, based on the current asset values received in block 52. Block 58 may be performed at any time after new values for one or more assets are available.

If for any asset the status is set to BUY or SELL then method 50 proceeds to block 60 which determines whether or not to recommend the purchase or sale of the asset (and, in some embodiments, determines how much of the asset to recommend buying or selling).

Block 62 determines a desired amount for at least each asset represented in portfolio record 12 for which the status is BUY or SELL. This may be done, for example, by computing a current total portfolio value and multiplying the current total portfolio value by the current desired allocation for each asset, (or for each asset having a status of BUY or SELL).

Block 64 determines a desired value adjustment for at least each asset having a status of BUY or SELL. Block 64 may comprise, for example, subtracting the current total value for the amount of each asset currently held in the portfolio from the desired value determined for the asset in block 62. This is done for at least the assets having a status of BUY or SELL. In this embodiment it is not necessary to determine the desired value for assets not having a status of BUY or SELL although this could be done.

Block 66A checks, at least for each of the assets having a status of BUY, whether the asset is below a desired allocation or is already at or exceeds the desired allocation. This may comprise, for example, for assets having a status of BUY determining whether the corresponding desired value adjustment determined in block 64 is positive.

Block 66B checks, at least for each of the assets having a status of SELL, whether the amount of the asset in the portfolio is above the desired allocation or is already at or below the desired allocation. This may comprise, for example, for assets having a status of SELL determining whether the corresponding desired value adjustment determined in block 64 is negative.

In the event of a YES decision for an asset in either one of blocks 66A and 66B then the corresponding one of blocks 67A and 67B is performed. Block 67A recommends buying more of the asset in an amount equal to the current value adjustment corresponding to the asset or the amount available in the safe fund, whichever is less. Block 67B recommends selling some of the asset. The amount of the asset to recommend selling is equal to the current value adjustment corresponding to the asset or the amount of the asset being held in the portfolio, whichever is less. In most embodiments the current value adjustment for an asset will always be less than an amount of the asset held in the portfolio. After blocks 67A and/or 67B, method 50 may optionally proceed to block 69, which implements any recommended purchase(s) and/or sale(s).

It can be desirable to perform block 66B first and then block 66A since funds from any sales of assets as recommended in block 67B can then be considered available for the purchase of other assets as recommended in block 67A. However, embodiments in which blocks 66A and 66B may be performed in either order or in parallel are possible.

Various options are possible in the event of a NO decision for an asset in either one of blocks 66A and 66B. A NO decision indicates that performing a buy or sell action according to the current status for the asset would cause the amount of the asset being held in the portfolio to move away from the desired allocation. Some example ways that this may be handled in different embodiments of the invention are:
Set the value adjustment (VA) for the asset to zero and/or skip blocks 67A, 67B and 69 for the asset so that the amount of the asset in the portfolio does not change;
Perform block 67A or 67B and 69 anyway (effectively ignoring the desired asset allocation);
Limit and/or reduce the amount of the asset to be recommended for purchase or sale;
Permit a user to select a course of action;
Some combination of the above;
etc.

In an example embodiment, in the event of a NO decision for an asset in either one of blocks 66A and 66B the value adjustment is set in block 68 to an amount such that buying or selling an amount of the asset equal in value to the value adjustment would result in the portfolio holding the same value of the asset as was present in the portfolio prior to the start of the run that resulted in the asset being accorded its status of BUY or SELL. For example, if at the beginning of a gain run a portfolio holds 12000 units of an asset valued at $1 per unit (total asset value $12000) and the asset gains 2.5% in value (so that its total value is $12,300) by the end of the period for which a SELL status is accorded to the asset and, at the end of that period, the desired allocation for that asset indicates that the value of the asset in the portfolio should be $15,000 (for example, due to increases in the values of other assets in the portfolio, such that the total value of the portfolio is greater) then the value adjustment may be set to recommend the sale of $300 worth of the asset (293 units).

Some embodiments provide parameters that allow other departures from the desired allocation when buying or selling assets in a portfolio. For example a “buy amount” and a “sell amount” may be provided. The buy/sell algorithm may be configured so that when a purchase or sale of an asset is recommended, the buy/sell algorithm will recommend buying or selling enough of the asset so that the asset accounts for the desired allocation as a fraction of the total portfolio times the buy amount.

In such embodiments, if the buy amount is set to 100%, the buy/sell algorithm will recommend buying enough of the asset so that the asset value in the portfolio matches its allocation. If the buy amount is greater than 100%, the buy/sell algorithm will recommend buying more of the asset so that the value of the asset in the portfolio equals <Asset Allocation>×<Buy Amount>. Such a purchase, if implemented will result in the portfolio containing more of the asset than specified by the allocation immediately after the purchase occurs. If the buy amount is less than 100%, the buy/sell algorithm will recommend purchase of fewer units of the asset. In this case, if the recommended purchase is implemented then the portfolio would contain less of the asset than specified by the allocation immediately after the purchase occurs.

Similarly, the buy/sell algorithm may be configured so that, when a sale of an asset is recommended, the algorithm recommends selling enough of the asset so that the value of the asset in the portfolio will equal <Asset Allocation>×<Sell Amount> immediately after the sale. The sell amount may be set to be less than equal to or above 100% in some embodiments.

In some embodiments, buy amount and sell amount are parameters that are optimized as described above.

The recommendations in blocks 67A and/or 67B may be relayed to a user in any suitable way. For example, the recommendations may be displayed on a display, printed in a report, automatically sent in an e-mail or other electronic notification, provided to another automatic system, stored in a data store, and/or the like. The recommendations may be communicated to the user together with other information that the user can review for assistance in determining whether to implement the recommendations. For example, the other information may comprise information regarding how far out of balance the portfolio is (e.g. how large is the difference between the current and desired asset allocation, the amount by which the current asset value change is over the sell level or below the buy level, and the like).

In the illustrated embodiment, block 69 automatically initiates purchases or sales of assets to implement the recommendation(s) made in blocks 67A and 67B. Block 69 may include an authorization step that requires a user to assent to the proposed purchases and/or sales by way of a suitable user interface control. In some embodiments block 69 is not provided by method 50. In some embodiments, block 69 automatically updates portfolio record 12 with changes resulting from the execution of block 69.

As noted above, in block 58, method 50 automatically updates the buy levels 17 and the sell levels 18 corresponding to different assets as current value information is received for those assets. The updated buy levels 17 and sell levels 18 may be determined as described above with reference to block 20 for example. In some embodiments, buy levels 17 and sell levels 18 are calculated based upon historical values for the corresponding asset in a window extending back for a predetermined time from the present. For example, the buy levels 17 and sell levels 18 may be based upon the most-recent periods of value data for each asset.

In some embodiments, buy and sell levels for a number of assets (for example in the form of gain multipliers or drop multipliers) may be maintained at a server that keeps the buy levels and sell levels up to date as current value data is received for different assets. The server may maintain a number of different sets of buy and sell levels corresponding to different levels of risk tolerance. The server may provide the buy and sell levels for indicated assets to local workstations on request. This architecture can relieve the local work stations of the computational burden of maintaining buy and sell levels.

FIG. 3A is a flow chart illustrating a method 50A according to an example embodiment. Blocks 52 and 54 may be as described above. In block 70 the current total value of the portfolio is determined. In block 72 value adjustments are determined for assets in the portfolio. The value adjustments may be determined, for example by subtracting a current actual asset value from a desired asset value. For example, the value adjustment VA may be determined as follows:

VA=PV*DA−CV (1)

where PV is the total portfolio value; DA is the desired allocation for the asset; and CV is the current value for the asset in the portfolio. For example, consider the case where a portfolio has a value of $145,000, an asset has a desired allocation of 15% and the actual value of the asset in the portfolio is $23,000. In this case the value adjustment is $21,750-$23,000=−$1,250.

In blocks 72 and 73 the change in each asset value in the current run (as determined in block 54) is compared to the buy and sell levels for the corresponding asset. A NO result in both of blocks 72 and 73 loops back to block 52 as indicated by 74.

A YES result in block 72 causes method 50A to proceed to block 75 which tests the value adjustment to determine whether it is positive (NO result) indicating that purchasing the asset will cause the asset value to approach the desired asset value. If so, method 50A proceeds to block 75A which signals a buy recommendation. Otherwise, method 50A returns to block 52 by way of path 76. In some embodiments the buy recommendation specifies that the asset should be purchased in an amount equal to the current value adjustment corresponding to the asset or the amount in the safe fund, whichever is less.

A YES result in block 74 causes method 50A to proceed to block 77 which tests the value adjustment to determine whether it is negative (NO result) indicating that selling some of the asset will cause the asset value to approach the desired asset value. If so, method 50A proceeds to block 77A which signals a sell recommendation. Otherwise, method 50A returns to block 52 by way of path 76. In some embodiments the sell recommendation recommends selling an amount of the asset equal to the current value adjustment corresponding to the asset or the entire amount of the asset, whichever is less.

If either a buy recommendation is signalled in block 75A or a sell recommendation is signalled in block 77A then method 50A proceeds to optional block 79 which implements any buy and sell recommendations. As described above, block 79 may automatically initiate purchases or sales of assets to implement the recommendation(s) made in blocks 75A and 77A (after the purchase(s) or sale(s) have been approved by an authorized user, if necessary). Blocks 71 and onwards in method 50A are executed on an asset by asset basis for each asset in portfolio record 12.

Method 50A may be repeated automatically on a periodic basis to provide ongoing buy and sell recommendations as current asset values fluctuate. The periodicity of method 50A may be preset or user defined. In some embodiments, execution of method 50A is triggered upon the availability of updated value data for any assets identified in a portfolio record.

Method 50A may be modified to include blocks which update parameter values (such as values affecting whether or not to recommend buying or selling an asset (e.g. buy level, sell level), values affecting whether or not to identify a most recent period as part of a run for an asset (e.g. gain run end and drop run end values), values affecting how much of an asset to buy or sell (e.g. values affecting how rigidly the method attempts to bring the values of assets held in a portfolio toward a desired allocation), values affecting how much value is kept in the safe account for a portfolio, etc.). Such updating may be based at least in part on current and historical value data for assets in a portfolio. Updating of parameters may be done either synchronously or asynchronously with the execution of other operations of method 50A.

Methods according to some embodiments determine desired allocations of the assets represented in portfolio record 12 as a fraction of the total value of the portfolio. In some embodiments the desired allocation is predetermined. In some embodiments the desired allocation is user specified. In some embodiments a method comprises generating a recommended allocation based at least in part upon the historical value data 22 for the assets represented in portfolio record 12. Methods according to some embodiments comprise periodically adjusting a desired allocation based at least in part upon updated historical value data 22 for the assets represented in portfolio record 12. FIG. 3B shows a block 80 that may be performed at a suitable place in a method. Block 80 determines a desired allocation among assets in a portfolio.

Allocation may comprise receiving user input specifying a desired allocation. A user interface may provide a box or other input mechanism into which a user can enter a desired allocation for each asset in a portfolio. The tool may check to ensure that the allocations (including any amount allocated to the safe fund) sum to 100%.

The method may comprise providing the user with computed results that are of value in selecting an appropriate allocation.

In some embodiments, each asset being considered for a portfolio is analyzed independently alongside the safe fund to determine a reasonable allocation to that asset. After relative allocations to the assets other than the safe fund have been allocated then a decision may be made regarding a desired allocation between the safe fund and other assets. For example, consider a portfolio made up of ten assets plus the safe fund. A manager could run a simulation for each of the ten assets, as described above. Based upon the results of the simulation and the manager's professional judgment the manager could enter a desired relative allocation among the ten assets. Suppose, for example, that the manager decides that the portfolio should have equal amounts of each of the ten assets (10% of each asset). The manager can then cause the tool to perform simulations based upon the desired allocation among the ten assets with various allocations between the safe fund and other assets. Based upon the results of these simulations and the manager's professional judgment the manager may enter a desired allocation between the safe fund and the other assets. Suppose, for example, that this desired allocation is 50% safe fund to 50% other assets. Then the desired allocation will be 5% to each asset other than the safe fund and 50% to the safe fund. The simulation can then be re-run with various allocations among the assets and the manager can decide on an optimum allocation among the assets in the portfolio.

After a portfolio has been created then the relative desired allocations among assets in the portfolio and the desired relative allocations between the safe fund and other assets may be revisited from time to time (e.g. annually). At such times a manager may determine whether the desired allocations ought to be changed as a result of changes in the goals for the portfolio or changes in the behavior of the assets in the portfolio (e.g. assets may become more or less volatile).

In some embodiments, the allocation in block 80 includes an allocation to the safe fund for the portfolio. In the illustrated embodiment block 80A comprises computing a recommended allocation to the safe fund. Block 80A may comprise performing a simulation to determine how volatile the portfolio would have been based upon the historical data. The greater the volatility, most likely the higher the percentage should be allocated to the safe-fund.

A factor in establishing an allocation between the safe fund and other assets is how negatively correlated the performance (gains or drops) of the other assets are to one another. If the other assets have a strong negative correlation (i.e. some tend to gain at the same time as others tend to drop and vice versa) then the portfolio will tend to be less volatile and a lower relative allocation to the safe fund may be optimal. On the other hand, where the performance of the other assets have a positive correlation (i.e. they tend to rise and fall together) or not a significant negative correlation then the performance of the portfolio overall may be more volatile and a higher allocation to the safe fund may provide better results.

In some embodiments block 80A comprises determining correlations between the historical performance of the assets in the portfolio and basing a recommended allocation to the safe fund on the correlations.

In some embodiments, the tool determines whether, during a simulation, an amount in the safe fund is drawn down to zero and generates a signal to alert a user of this fact. Where the amount in the safe fund is drawn to zero at some point in a simulation there may be a possibility that overall results could be improved by increasing a relative desired allocation to the safe fund.

In some embodiments, a recommended desired allocation to the safe fund is based in part on the time period for which historical data for the assets in a portfolio is available. An investment cycle typically lasts for five to 10 years. Where historical data going back at least 5 to 10 years is unavailable for assets representing a significant desired allocation within a portfolio then the tool may automatically signal this fact to a user or automatically recommend an increased allocation to the safe fund.

FIG. 3C illustrates an example portfolio record 12A representing a portfolio containing individual assets ASSET-1 to ASSET-X. In the illustrated embodiment, portfolio record 12A has: a column 81A containing asset IDs; a column 81B containing a number of units of each asset held in the portfolio; a column 81C containing a unit value for each asset; a column 81D containing a gain multiplier for each asset; a column 81E containing a drop multiplier for each asset; a column 81F containing gain end value for each asset; a column 81G containing a drop end value for each asset; and a column 81H containing a desired allocation for each asset.

Portfolio record 12A contains or is linked to a safe fund balance 82 and may contain or be linked to additional information regarding the portfolio. Such additional information is omitted in example portfolio record 12A.

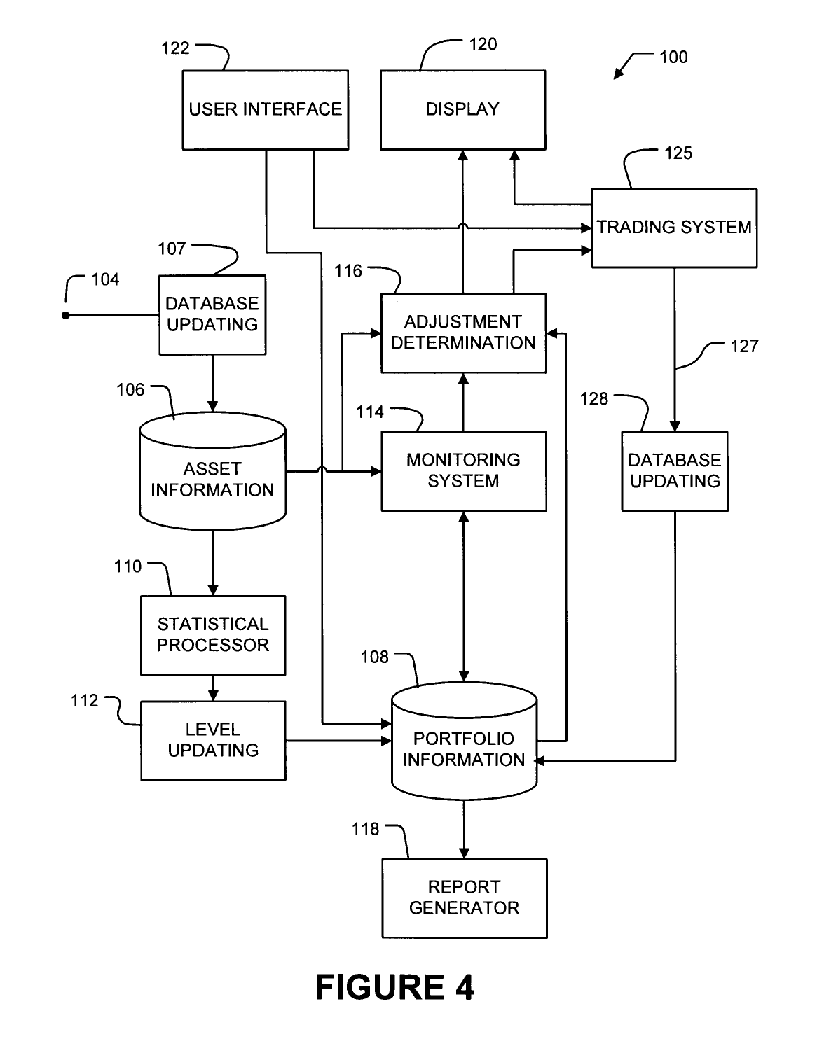

FIG. 4 is a block diagram of a tool 100 according to an example embodiment. Tool 100 comprises an input 104 which is connected to receive a feed of value data for assets in portfolios managed with the assistance of tool 100. An asset information database 106 contains historical value data for the assets. A database updating component 107 automatically updates database 106 with new asset valuation data received at input 104. A portfolio information database 108 stores portfolio records containing information regarding the portfolios being managed with the assistance of tool 100.

A statistical processor 110 is configured to retrieve information about assets from asset information database 106. In an example embodiment, processor 110 extracts information regarding runs in historical values for assets. For example, processor 110 may obtain information including one or more of: average gain per gain run, average drop per drop run, average length of gain runs, average length of drop runs, standard deviation (or other variance measure) of gains in gain runs, standard deviation (or other variance measure) of drops in drop runs, and the like.

A level updating system 112 is configured to update buy levels and sell levels for assets based upon the corresponding values provided by statistical processor 110 or other information about assets retrieved from asset information database 106. In an example embodiment, level updating system 112 determines average gains over gain runs and average losses over loss runs based in part on up-to-date data in asset information database 106 and multiplies these values by gain multipliers and drop multipliers respectively. Level updating system 112 is configured to write the updated buy and sell levels to portfolio information database 108.

In some embodiments, level updating system 112 performs optimizations based on up-to-date data in asset information database 106 to determine new values for gain multipliers, drop multipliers or other parameters that set buy and sell levels. Level updating system 112 may optionally determine other parameters such as gain end value and drop end values. Level updating subsystem 112 may involve any suitable optimization algorithm (which determines, for example, buy and sell levels that maximize the increase in value of the asset or minimize the volatility in the value of the asset over a desired historical period). In some embodiments, level updating system 112 presents recommended optimized values to a user and provides the user with the option of accepting the recommended values or substituting values of the user's choosing.

A monitoring system 114 is configured to compare current changes in asset value (from asset information database 106 or input 104) to corresponding buy and sell levels and to set a status for assets in portfolios represented in portfolio information database 108 to BUY, SELL or HOLD, as appropriate. In some embodiments, monitoring system 114 is configured to write status information to portfolio information database 108.

An adjustment determining system 116 determines an amount (the amount can be zero in some cases) by which an asset value should be increased (by buying more of the asset) or decreased (by selling some or all of the asset). Adjustment determining system 116 receives as inputs status information generated by monitoring system 114, current asset value information from asset information database 106 and allocation information from portfolio information database 108 and balance information for a corresponding safe account from portfolio information database 108. Adjustment determining system 116 is configured to output recommended trades of assets in portfolios represented in portfolio information database 108. Monitoring system 114 and adjustment determining system 116 may collectively implement a buy/sell algorithm as described herein.

A report generator 118 generates reports regarding transactions regarding portfolios represented in portfolio information database 108.

A display 120 is provided to display information generated by tool 100. The information may include trade recommendations made by adjustment determining system 116. A user interface 122 is provided to allow users to control and provide information to tool 100, for example to approve trades recommended by adjustment determining system 116 or to change portfolio information (such as, for example, the desired allocation of assets) in portfolio information database 108.

In some embodiments, adjustment determining system 116 is configured to provide trading instructions to a trading system 125. Trading system 125 implements trades to buy and/or sell assets and returns trade confirmations 127 to a database updating component 128 that updates portfolio information database 108 to reflect the current holding of assets within the portfolio.

It is currently most cost effective to implement the functional components of tool 100 by providing computer software which executes on a computer system having one or more data processors, one or more data stores, a user interface and a display. The computer software contains instructions that cause the one or more processors to perform methods as described herein. The computer software may implement specific algorithms as described herein. However, the functional components may also be implemented in whole or in part by hard-wired or configurable logic circuits. It is not mandatory that the individual functional components making up tool 100 be distinct. Two or more of the functional components may be integrated together with one another.

For example, tool 100 may be implemented on a computer system having a communications port connected to the Internet, a secured private network, or other computer network. In such embodiments, input 104 may use the communications port to obtain asset value data, either by sending requests for updated asset values to a remote computer system, or by receiving automatic updates of asset values, either periodically or when there is any change in asset values. Similarly, trading system 125 may use the communications port to implement trades by sending requests to buy or sell assets to a remote computer system. For example, trading system 125 may be provided with a user's subscriber information for an electronic asset trading system such as an electronic communications network (ECN) registered with the SEC or other regulatory agency. Trading system 125 may be programmed to implement trades by sending buy/sell requests in a format accepted by the ECN that include the user's subscriber information, such that the purchase or sale of assets may be implemented through the ECN, either automatically upon generation of a buy/sell recommendation by adjustment determining system 116, or after receiving user approval of trades through user interface 122.

In an example embodiment, the invention is embodied in apparatus comprising a data processor, an input or data store comprising historical asset data, a program store comprising computer-readable instructions that can be executed by the data processor to perform algorithms as described herein and a user interface configured to communicate results of those algorithms to a user. The results may comprise one or more of: current portfolio value; recommendations to buy and/or sell assets in a portfolio; recommended amounts of assets in a portfolio to be bought or sold; for example. In a specific example embodiment the computer-readable instructions comprise computer object code compiled by a compiler for a suitable programming language such as, without limitation, C#, C++, Java, Python, and the like.

The functional elements of a system as described herein may be applied in various ways in addition to those described above. For example:
Analysis of historical data 22 may be performed for a wide variety of assets and the results may be applied to determine which assets to acquire for a portfolio. This may be done when initializing a new portfolio or when there is cash available in a portfolio for purchasing new assets. For example, changes of value of the wide variety of assets in their current runs can be compared to buy levels for those assets (the buy levels based at least in part on the average drop per drop run or equivalent for the assets in question as determined from historical data 22). Assets for which the current run is a drop run having a drop that is large in comparison to the buy level may be automatically identified for consideration.
The methods and tools described herein may be applied to assist in management of portfolios for which there is no predetermined fixed set of assets to be included in the portfolios. The methods and tools may be configured to permit recommendations that the entire holding of an asset in a portfolio be liquidated or that cash from the portfolio (e.g. value from a safe fund) be invested in an asset not currently included in the portfolio.
In some embodiments methods or apparatus are configured to generate a warning (such as an automatic e-mail, displayed warning, printed report or the like) when an asset is approaching a buy recommendation or a sell recommendation. Such warnings may be generated, for example, by applying the same mechanism used to generate buy or sell recommendations but with a smaller value for the gain or drop multipliers.
Additional algorithms may be provided and run against historical data 22 and compared to the operation of the buy/sell algorithm. For example, some embodiments provide a module configured to simulate periodic conventional rebalancing. For example, the module may determine the desired asset values based on an initially-determined allocation at specified times and simulate the return that would have been provided by the portfolio had rebalancing done by at specified times, selling the amount of any asset that exceeds the desired asset value for that asset and using the proceeds to purchase the amount of any asset that is below the desired asset value for that asset. The simulated results provided by the rebalancing module may be compared to those provided by the buy/sell algorithm.

### Illustrative Example #1

Lucy is a fund manager. She manages a portfolio of several stocks held by a mutual fund. One of her jobs is to purchase and sell the stocks that make up the fund to maintain a desired balance within the fund. Lucy exercises her own professional skill and judgment in placing trades of stocks held by the mutual fund. Lucy uses a tool that performs a method like method 10 of FIG. 1 for assistance. The tool is connected to receive live value information for the stocks held by the mutual fund while the stock markets are open. The tool includes a display that provides useful information to Lucy such as:
which of the stocks in the portfolio have recommendations to BUY according to a method as described herein;
which of the stocks in the portfolio have recommendations to SELL according to a method as described herein;
what is the current allocation of value in the portfolio;
how the current allocation of value in the portfolio compares to the desired allocation of value in the portfolio; and
the like.

Lucy uses the information provided by the tool to inform her decisions regarding what stocks to trade, when to make trades and so on. Lucy makes trades by way of a computer system that automatically provides information back to the tool regarding the current makeup of the portfolio.

### Illustrative Example #2

Quarles manages portfolios made up of stocks, mutual funds and index funds for a number of clients who have entrusted Quarles with the discretion to make trades on their behalf. Quarles sets up a portfolio for each of the clients that includes a number of selected securities plus a safe cash account. Quarles determines an appropriate allocation of value among the assets for each portfolio and enters details of each portfolio into a tool that implements a method like method 10 of FIG. 1.

Quarles exercises his own professional skill and judgment in placing trades of stocks held by his clients. Quarles' tool is connected to receive live value information for the stocks held by his clients. The tool includes a display that provides useful information to Quarles such as:
which of the stocks in the portfolio have recommendations to BUY according to a method as described herein;
which of the stocks in the portfolio have recommendations to SELL according to a method as described herein;
what is the current allocation of value in the portfolio;
how the current allocation of value in the portfolio compares to the desired allocation of value in the portfolio; and
the like.

Quarles' tool is interfaced to a trading system which can implement trades of the assets held by Quarles' clients on Quarles' instructions. The tool includes a user interface control that Quarles can activate to accept a trade suggested by the tool. The control, when actuated, causes the trading system to implement the trade suggested by the tool. Information from the trading system is automatically fed back to the tool so that the tool bases recommendations upon the actual makeup of each portfolio.

In some cases, to assist Quarles in managing a large number of client portfolios, the tool may display suggested trades (purchases or sales) of assets for multiple portfolios at the same time. In such embodiments, the tool may provide Quarles with a single control that allows Quarles to signify his acceptance of multiple trades recommended by the tool.

### Illustrative Example #3

A bank manages portfolios of mutual funds for a large number of investors. The investors have agreed to allow the bank to manage their portfolios by automatically rebalancing the portfolios according to the recommendations provided by a method like method 10, 50 or 50A.

When a new investor opens a portfolio with the bank, a bank employee interviews the investor and helps the investor to select an initial set of assets. The bank has a computer system. The bank employee opens an account for the new investor in the computer system and selects the assets to be included in the account.

The computer system recommends an initial allocation of value among the chosen assets based upon the historical data for those assets, as described above.

Subsequent to the initialization of a new portfolio, the bank's computer system executes method 10 as described above. When the system determines that cash from the safe account should be used to purchase more of an asset or that an asset should be sold then the bank's computer system automatically generates trading instructions. The trading instructions are automatically executed and logged. Statements are periodically generated automatically and delivered to the investors.

A portfolio manager supervises the proper operation of the system.

Certain implementations of the invention comprise computer processors which execute software instructions which cause the processors to perform a method of the invention. For example, one or more processors in a personal computer, internet-connected application server or mainframe computer may implement methods as described herein by executing software instructions in a program memory accessible to the processors. The invention may also be provided in the form of a program product. The program product may comprise any tangible medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

### Some Example Alternative Embodiments

In general, where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

In some embodiments value data for assets is pushed to a tool. In other embodiments, the tool periodically requests the value data that it needs.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. Apparatus for use in managing financial portfolios, the apparatus comprising a processor and a program store containing instructions configured to cause the processor to:
identify gain runs and drop runs in historical value data for an asset;
determine statistical information regarding the gain runs and drop runs in the historical value data; and
set a buy level for the asset based at least in part upon the statistical information regarding the drop runs and a sell level for the asset based at least in part upon the statistical information for the gain runs.

2. Apparatus according to claim 1 wherein the instructions are configured to cause the processor to set the buy level based upon an average drop per drop run in the historical value data.

3. Apparatus according to claim 1 wherein the instructions are configured to cause the processor to set the sell level based upon an average gain per gain run in the historical value data.

4. Apparatus according to claim 1 comprising a parameter store configured to store one or more parameter values wherein the parameter values include at least a gain end value, the gain end value is negative, and identifying gain runs comprises identifying sequences of periods in the historical value data for the asset over which the value of the asset increases and the amount of increase in each period is at least the gain end value.

5. Apparatus according to claim 1 comprising a parameter store configured to store one or more parameter values wherein the parameter values include at least a drop end value, the drop end value is positive, and identifying drop runs comprises identifying sequences of periods in the historical value data for the asset over which the value of the asset decreases and the amount of decrease in each period is at least the drop end value.

6. Apparatus according to claim 1 wherein the instructions are configured to cause the processor to:
obtain current value data for the asset; and,
determine a change in value of the asset for a current run.

7. Apparatus according to claim 6 wherein the instructions are configured to cause the processor to:
output a recommendation to sell the asset if the change in value of the asset for the current run is positive and at least the sell level.

8. Apparatus according to claim 7 wherein the recommendation to sell the asset comprises a sell amount, the sell amount equal to the lesser of an entire amount of the asset in the portfolio and a value adjustment for the asset, wherein the value adjustment is determined based on a comparison of an actual total value of the asset in the portfolio and a desired allocation for the asset in the portfolio.

9. Apparatus according to claim 7 wherein the instructions are configured to cause the processor to:
output a recommendation to purchase the asset if the change in value of the asset for the current run is negative and at least the buy level.

10. Apparatus according to claim 9 wherein the recommendation to purchase the asset comprises a purchase amount, the purchase amount equal to the lesser of an amount corresponding to a current amount in a safe fund of the portfolio and a value adjustment for the asset, wherein the value adjustment is determined based on a comparison of an actual total value of the asset in the portfolio and a desired allocation for the asset in the portfolio.

11. Apparatus according to claim 9 wherein the instructions are configured to cause the processor to:
automatically implement recommended sales and purchases by sending sale and purchase requests over an electronic communications network.

12. Apparatus for use in managing financial portfolios, the apparatus comprising a processor and a program store containing instructions configured to cause the processor to:
identify gain runs and drop runs in value data for an asset;
compare a gain in value for the asset in a current gain run to a sell level; and
output a recommendation to sell the asset if the gain in value for the current gain run is at least the sell level.

13. Apparatus according to claim 12 wherein the instructions are configured to cause the processor to: compare a drop in value for the asset in a current drop run to a buy level; and
output a recommendation to purchase the asset if the drop in value for the current drop run is at least the buy level.

14. An automated method for use in managing financial portfolios, the method comprising:
automatically identifying gain runs and drop runs in historical value data for an asset stored in an asset information database;
extracting, with a statistical processor, statistical information regarding the gain runs and drop runs in the historical value data; and
setting a buy level for the asset based at least in part upon the statistical information regarding the drop runs and a sell level for the asset based at least in part upon the statistical information for the gain runs.

15. A method according to claim 14 comprising:
obtaining current value data for the asset; and,
determining a change in value of the asset for a current run.

16. A method according to claim 15 comprising:
outputting a recommendation to sell the asset if the change in value of the asset for the current run is positive and at least the sell level.

17. A method according to claim 16 comprising:
outputting a recommendation to purchase the asset if the change in value of the asset for the current run is negative and at least the buy level.

18. A method according to claim 17 comprising:
automatically implementing recommended sales and purchases by sending sale and purchase requests over an electronic communications network.

19. An automated method for use in managing financial portfolios, the method comprising:
identifying gain runs and drop runs in value data for an asset stored in an asset information database;
comparing a gain in value for the asset in a current gain run to a sell level; and
outputting a recommendation to sell the asset if the gain in value for the current gain run is at least the sell level.

20. A method according to claim 19 comprising
comparing a drop in value for the asset in a current drop run to a buy level; and
outputting a recommendation to purchase the asset if the drop in value for the current drop run is at least the buy level.
